(19) United States
(12) Patent Application Publication
(10) Pub. No.: US 2026/0274578 A1
(43) Pub. Date: Sep. 17, 2026

(54) LOAD CARRIER TRANSPORT MECHANISM

(71) Applicant: Jtec Industries, Inc., EAST PEORIA, IL (US)

(72) Inventors: Joseph Knepp, Morton, IL (US); Brady Watson, Washington, IL (US); Nicholas Kaiser, Morton, IL (US)

(73) Assignee: Jtec Industries, Inc., EAST PEORIA, IL (US)

(21) Appl. No.: 19/075,980

(22) Filed: Mar. 11, 2025

(51) Int. Cl. B65G 17/12; B65G 23/00

(52) U.S. Cl. CPC B65G 17/12; B65G 23/00

(57) ABSTRACT

A transport mechanism for a load carrier includes a frame, a conveyor bed, a traversing unit, a gripping mechanism, and a motor. The frame includes a front end, a rear end, a first side, and a second side. The conveyor bed is coupled to the frame and forms a loading surface with a loading end at the front end of the frame. The traversing unit is movably coupled to the frame and is configured to traverse along the loading surface in a direction of the rear end to the front end of the frame. The gripping mechanism is coupled to the traversing unit and is configured to grip a load carrier. The motor drives the traversing unit towards the front end such that the gripping mechanism is disposed at the loading end of the conveyor bed and retracts the traversing unit towards the rear end of the frame.

### FIELD OF THE INVENTION

The present invention relates to transporting load carriers, such as pallets. The present invention also relates to transporting load pallets in an industrial setting.

### BACKGROUND OF THE INVENTION

Pallet transport in warehouses involves the efficient movement of goods stored on pallets to optimize storage, retrieval, and distribution processes. Pallets, typically made of wood, plastic, or metal, serve as a stable platform for stacking and securing items. In warehouses, pallets are conveyed using a variety of systems designed to move them efficiently through different areas, such as storage, processing, and shipping zones. Conveyor systems, which include roller conveyors, chain conveyors, and belt conveyors, are commonly used for automated pallet transport. Roller conveyors are ideal for moving pallets along straight paths or inclines, while chain conveyors handle heavier loads and facilitate movement across complex layouts.

In warehouses and material handling systems, stationary areas refer to designated locations where goods or pallets remain static for specific purposes. These areas are not part of the active flow of goods along conveyors or other transport systems. Stationary areas often include loading/unloading zones, storage racks, inspection stations, packing stations, or staging areas where pallets or goods are temporarily held before being moved to the next phase of operations.

Pallets are removed from stationary areas using a range of equipment suited to the specific needs and level of automation. Forklifts are the most common option, offering versatility for lifting and transporting pallets across the facility. Pallet jacks, either manual or powered, are often used for shorter distances or in smaller-scale operations. To unload pallets from the stationary areas, powered mechanisms installed at the stationary area are commonly used.

In view of the foregoing, it is desirable to develop improved pallet transport mechanisms that safely and efficiently retrieve pallets from stationary areas and transport pallets to other locations within a warehouse.

### SUMMARY OF THE INVENTION

A feature of the present invention is to provide a transport mechanism for transporting load carriers in an industrial setting.

Another feature of the present invention is to provide a transport mechanism for transporting pallets from a stationary area of a pallet conveyor system in an industrial setting.

A further feature of the present invention is to provide a transport mechanism for transporting pallets from a stationary area, reducing or eliminating the need for additional power mechanisms installed as part of the stationary area.

An additional feature of the present invention is to provide a transport mechanism coupled to an autonomous mobile robot for transporting pallets from a stationary area of a pallet conveyor system in an industrial setting.

Another feature of the present invention is to provide a method of using a transport mechanism for transporting pallets in an industrial setting.

Additional features and advantages of the present invention will be set-forth in part in the description that follows, and in part will be apparent from the description, or may be learned by practice of the present invention. The objectives and other advantages of the present invention will be realized and attained by means of the elements and combinations particularly pointed out in the description and appended claims.

To achieve these and other advantages, and in accordance with the purposes of the present invention, as embodied and broadly described herein, the present invention relates to a transport mechanism for a load carrier. The transport mechanism includes a frame including a front end, a rear end, a first side, and a second side. The transport mechanism further includes a conveyor bed coupled to the frame, the conveyor bed including a loading surface and a loading end at the front end of the frame. A traversing unit is movably coupled to the frame. The traversing unit is configured to traverse along the loading surface in a direction from the rear end to the front end of the frame. A gripping mechanism is coupled to the traversing unit and configured to grip a load carrier. The transport mechanism further includes a motor configured to drive the traversing unit. Upon a first activation the motor drives the traversing unit towards the front end such that the gripping mechanism is disposed at the loading end of the conveyor bed and upon a second activation the motor retracts the traversing unit towards the rear end of the frame.

The present invention can further include a method of transporting a load carrier from a stationary area in a warehouse. The method includes mounting a transport mechanism to an autonomous mobile robot. The method further includes programing the autonomous mobile robot to autonomously traverse the warehouse including at least traversing to the stationary area and from the stationary area to an endpoint. The autonomous mobile robot traverses the warehouse to the stationary area. The motor of the transport mechanism drives the traversing unit to the loading end of the conveyor bed. The gripping mechanism of the transport mechanism grips the load carrier disposed on the stationary area. The motor retracts the traversing unit towards the rear end of the frame of the transport mechanism, thereby loading the load carrier onto the conveyor bed. The autonomous mobile robot traverses the warehouse to the endpoint. At the endpoint, the motor of the transport mechanism drives the traversing unit to the loading end of the conveyor, thereby unloading the load carrier from the conveyed bed, the gripping mechanism of the transport mechanism releases the grip of the load carrier, and the motor retracts the traversing unit towards the rear end of the frame.

It is to be understood that both the foregoing general description and the following detailed description are exemplary and explanatory only and intended to provide a further explanation of the present invention, as claimed.

### BRIEF DESCRIPTION OF THE DRAWINGS

The invention may be more fully understood with reference to the accompanying drawings. The drawings are intended to illustrate, not limit, the present teachings, according to an embodiment of the present invention.

FIG. 1A is a front perspective view of a transport mechanism of an embodiment of the present invention.

FIG. 1B is a rear view of the transport mechanism of FIG. 1A.

FIG. 1C is a side view of the transport mechanism of FIG. 1A.

FIG. 1D is a rear perspective view of the transport mechanism of FIG. 1A.

FIG. 2 is a top view of a transport mechanism of an embodiment of the present invention, illustrating a carriage in a retracted state.

FIG. 3 is a top view of a transport mechanism of an embodiment of the present invention, illustrating a carriage in an extended state.

FIG. 4A is a rear view of a transport mechanism of an embodiment of the present invention, illustrating the transport mechanism mounted to an autonomous mobile robot and further illustrating internal components of the transport mechanism.

FIG. 4B is a detail view of the transport mechanism shown in FIG. 4A.

FIG. 5A is a rear perspective view of a transport mechanism of an embodiment of the present invention, illustrating the transport mechanism mounted to an autonomous mobile robot and further illustrating internal components of the transport mechanism.

FIG. 5B is a detail view of the transport mechanism shown in FIG. 5A.

FIG. 5C is a detail view of the transport mechanism shown in FIG. 5A.

FIG. 6A is a side view of a transport mechanism of an embodiment of the present invention, illustrating the transport mechanism mounted to an autonomous mobile robot and further illustrating internal components of the transport mechanism.

FIG. 6B is a detail view of the transport mechanism shown in FIG. 6A.

FIG. 7A is a top view of a transport mechanism of an embodiment of the present invention, illustrating a carriage in a retracted state.

FIG. 7B is a detail view of the transport mechanism shown in FIG. 7A.

FIG. 8A is a front perspective view of a transport mechanism of an embodiment of the present invention, illustrating the transport mechanism mounted to an autonomous mobile robot and further illustrating a carriage in an extended state.

FIG. 8B is a detail view of the transport mechanism shown in FIG. 8A.

FIG. 8C is a detail view of the transport mechanism shown in FIG. 8A.

FIG. 8D is a detail view of the transport mechanism shown in FIG. 8A, illustrating internal components of a gripping mechanism.

### DETAILED DESCRIPTION OF THE INVENTION

According to one or more embodiments, the present invention includes a transport mechanism for a load carrier. The transport mechanism can be used to transport load carriers within an industrial setting. The transport mechanism includes a frame having a front end, a rear end, a first side, and a second side. A conveyor bed is coupled to the frame and includes a loading surface. The conveyor bed includes a loading end at the front end of the frame. A traversing unit is movably coupled to the frame and is configured to traverse along the loading surface in a direction from the rear end to the front end of the frame. A gripping mechanism is coupled to the traversing unit and is configured to grip the load carrier. A motor is configured to drive the traversing unit. Upon a first activation the motor drives the traversing unit towards the front end such that the gripping mechanism is disposed at the loading end of the conveyor bed and upon a second activation the motor retracts the traversing unit towards the rear end of the frame.

As used herein, “load carriers” are structures used for holding, supporting, and transporting goods, such as pallets, skids, crates, bins, containers, or racks. The load carriers are typically used in a warehouse setting.

The transport mechanism can be mounted to an autonomous mobile robot (AMR) and/or a tugged cart. An example of an AMR is an OTTO by ROCKWELL AUTOMATION, such as an OTTO 1500. The present invention is not limited to being used with an OTTO AMR and can be used with any autonomous mobile robot that is capable of carrying the transport mechanism and autonomously traversing an industrial setting. An example of a tugged cart can include any tugged cart provided by JTEC INDUSTRIES, such as those provided in US 11,014,593, US 11,273,857, US 11,214,439, and US 12,221,181, all of which are incorporated herein by reference. The present invention is not limited to being used with tugged carts from JTEC INDUSTRIES and can be used within any tugged cart that is capable of traversing in an industrial setting.

In operation, the AMR and/or tugged cart can drive the transport mechanism to a stationary area of a conveyor system. A load carrier with goods can be on the stationary area and ready for transport. When the loading end of the conveyor bed is aligned with the stationary area, the first activation can be initiated, during which the motor drives the traversing unit towards the front end such that the gripping mechanism is disposed at the loading end. The gripping mechanism can then grip the load carrier. The second activation can then be initiated, during which the motor retracts the traversing unit towards the rear end of the frame, such that the gripping mechanism pulls the load carrier onto the loading surface of the conveyor bed. The load carrier is then loaded onto the transport mechanism and the load carrier can be transported to another location within the warehouse.

Once the transport mechanism reaches the destination within the warehouse, the transport mechanism can unload the load carrier. To unload the load carrier from the transport mechanism, the first activation is initiated and the motor drives the traversing unit towards the front end, pushing the load carrier towards the loading end and then off of the loading surface of the conveyor bed. The gripping mechanism is activated to release the grip of the load carrier. The second activation is then initiated so that the motor retracts the traversing unit towards the rear of the frame to the traversing unit’s initial position.

As mentioned above, the conveyor bed includes a loading surface. A loading surface is defined herein as a surface that is capable of containing a load carrier, such as a pallet, thereon. The loading surface can be a planar loading surface or substantially planar loading surface that is within 5%, within 4%, within 3%, within 2%, or within 1% of being planar. The planar or substantially planar loading surface can include a plurality of rollers or wheels that are aligned at a consistent height to provide the planar or substantially planar loading surface.

The loading surface can be substantially horizontal when the transport mechanism is in an upright position. Substantially horizontal is defined herein as being horizontal or within 5%, within 4%, within 3%, within 2%, or within 1% of being horizontal.

The loading end of the conveyor bed and the conveyor bed can be sized to receive a standard load carrier, such as a standard pallet. For example, the conveyor bed can have a width of from 40 inches to 60 inches, from 42 inches to 58 inches, from 46 inches to 56 inches, from 48 inches to 54 inches, from 50 inches to 52 inches, or any range based upon any two values described herein. The width of the loading end of the conveyor bed can be the same or substantially similar to the width as the conveyor bed.

The conveyor bed can have a length of from 46 inches to 66 inches, from 48 inches to 64 inches, from 50 inches to 62 inches, from 52 inches to 60 inches, from 54 inches to 58 inches, from 55 inches to 57 inches, or any range based upon any two values described herein.

The conveyor bed can include conveying features that allow the load carrier to easily traverse the loading surface of the conveyor bed. For example, the conveying features can include a plurality of rollers, a friction surface, a plurality of wheels, air bearings, and the like or a combination thereof.

As an option, the conveyor bed includes a plurality of rollers substantially parallel to one another and extending in a direction from the first side to the second side. The plurality of rollers at least partially define the loading surface. The plurality of rollers can be rotatably secured to the frame such the plurality of rollers are aligned with minimal gaps, uniform spacing, and a consistent height.

As an option, the frame can further include a central partition running from the front end to the rear end along the conveyor bed. The central partition can partially define the loading surface. As an option, the central partition can be a friction surface, allowing the load carrier to easily glide along the central partition. The plurality of rollers can include a first set of rollers rotatably coupled to the first side and the central partition and a second set of rollers rotatably coupled to the second side and the central partition. The first set of rollers, the second set or rollers, and the central partition can define the loading surface. The frame can include more than one central partition and more than two sets of rollers.

As an option, the conveying features of the transport mechanism are non-powered. For example, the plurality of rollers are non-powered rollers.

The traversing unit is movably coupled to the frame such that the traversing unit travels along the loading surface in a direction from the rear end to the front end of the frame. Thus, the traversing unit can traverse the length of the transport mechanism. The traversing unit can be a traversing carriage. As an option, the traversing unit can be a telescopic traversing arm or arms, scissor linkage arms, a screw arm, a rack and pinion, or other type of linear actuator.

As mentioned above, the traversing unit can be a carriage. The carriage can traverse along a track of the frame. The track can extend along the frame in a direction from the front end to the rear end and the carriage is moveable along the track. The track can include a first rail extending along the frame at the first side and a second rail extending along the frame at the second side. The carriage can further include wheels that roll along the track. The track elevates the carriage above the loading surface.

As an option, the wheels can each include a circumferential V-groove and the circumferential V-groove guides the wheels along the first rail and the second rail. As an option, the first rail and the second rail can each include channels that guide the wheels along the first rail and the second rail.

As mentioned above, a motor is configured to drive the traversing unit. The motor can be coupled to the frame. The transport mechanism can further include a drive loop secured to the frame by rotaries. The carriage can be coupled to the drive loop and the motor drives the drive loop. When the motor drives, the drive loop, the traversing unit is driven along the length of the transport mechanism.

The drive loops can be chains, drive belts, or the like. The rotaries can include gears, pulleys, or the like. As an option, the transport mechanism can include a first pair of gears and a first chain wrapped around the first pair of gears. The transport mechanism can further include a second pair of gears and a second chain wrapped around the second pair of gears. When activated, the motor can rotate one of the first pair of gears, which in turn rotates the other of the first pair of gears by the first chain. A connector rod can connect the other of the first pair of gears to one of the second pair of gears. Thus, when the other of the first pair of gears rotates, the connector rod is rotated, which in turn rotates the second pair of gears, driving the second chain. The second chain can extend along the length of the transport mechanism. The carriage can be directly secured to the second chain. Thus, when the second chain is driven by the motor, the carriage traverses along the length of the transport mechanism by way of the track.

As an option, the transport mechanism can further include a third chain wrapped around a third pair of gears. The second chain and the second pair of gears can be disposed along the first side of the transport mechanism. The third chain and the third pair of gears can be disposed along the second side of the transport mechanism. The connector rod can be connected to one of the third pair of gears, and thus the third chain can be rotated when the motor is activated. The carriage can be connected to the second chain and the third chain, and can be driven backwards and forwards within the transport mechanism by the motor.

As an option, the motor can be located within the carriage. The carriage can drive wheels that are mounted to the carriage, allowing the carriage to traverse along the tracks.

The gripping mechanism is connected at the end of the traversing unit such that when the traversing unit is driven to the front end of the frame, the gripping mechanism is disposed at the loading end of the conveyor bed. The gripping mechanism can be any type of gripping mechanism that is capable of releasably securing to the load carrier. For example, the gripping mechanism can be openable and closeable jaws, a magnetic gripping mechanism, a hook or multiple hooks, a robotic arm, or the like.

As an option, the gripping mechanism includes a jaw configured to open and close. The jaw can be located at a front side of the carriage, which is facing towards the loading end. The gripping mechanism can further include an actuator that opens the jaw upon a first activation and closes the jaw upon a second activation.

As an option, the jaw of the gripping mechanism can include a first jaw member and a second jaw member. The first jaw member can be pivotably coupled to a first bracket mounted to the carriage. A first link can be pivotably coupled to the first jaw member at a first end and pivotably coupled to a connector rod at a second end. The second jaw member can be pivotably coupled to a second bracket mounted to the carriage. A second link can be pivotably coupled to the second jaw member at a first end and pivotably coupled to the connector rod at a second end. The connector rod is disposed within a guide, allowing the connector rod to move towards the jaw and away from the jaw. The connector rod can further be coupled to a linear actuator that moves the connector rod within the guide. Upon the first activation, the linear actuator pulls the connector rod back in the guide, which in turn opens the jaw. Upon the second activation, the linear actuator pushes the connector rod forward within the guide, which in turn closes the jaw and locks the jaw in place.

As an option, the jaw can include gripping portions at an end of the first jaw member and the second jaw member. For example, the gripping portions can include a plurality of spikes extending from the surfaces of the gripping portions, a textured surface, a rubber surface, or the like. The gripping portion allows the jaw to firmly grasp the load carrier.

As an example, the load carrier can be a pallet. The jaw can be sized to grasp a center stringer of the pallet to properly secure the pallet and load the pallet on the transport mechanism. The gripping mechanism that is configured to grasp a center stringer of the pallet can include an orientation at which the first jaw member and the second jaw member pivot about vertical axes. As an option, the jaw can be configured to grasp the top lead board and the bottom lead board of the pallet. The gripping mechanism that is configured to grasp the top and bottom lead boards can include an orientation at which the first jaw member and the second jaw member pivot about horizontal axes. The jaw can be adjusted in size and orientation based on the type of pallet or load carrier that the transport mechanism is configured to transport.

The transport mechanism can further include frame walls. The frame walls can extend vertically at the first side, the second side, and/or the rear side of the frame. A clearance is provided at the loading end. The frame walls can guide the load carrier onto the transport mechanism and off of the transport mechanism. The frame walls can prevent the load carrier from falling off of the transport mechanism while being transported.

The transport mechanism can further include a frame housing coupled to the frame. The frame housing can house electrical components of the present invention, such as printed circuit boards, a processor and memory, electrical wiring, the motor, and the like. As an option, the electrical wiring can include at least one power connector that extends from the frame housing. The power connector is configured to connect to a power source of the autonomous mobile robot and/or the tugged cart. As an option, the transport mechanism can include its own power source, such as a battery, housed within the frame housing. The power source can power the electrical components of the transport mechanism, such as the motor and the actuator of the gripping mechanism.

As an option, the transport mechanism can include emergency stop buttons. The emergency stop buttons can be placed at the front end of the frame and/or the rear end of the frame. The emergency stop buttons can be electrically connected by electrical wiring to the power source of the autonomous mobile robot and/or tugged cart. When the transport mechanism bumps into an object, the emergency stop buttons can be pressed, which automatically turns the power off of the autonomous mobile robot and/or tugged cart, and places the transport mechanism in a safe state.

As an option, the transport mechanism can include one or more sensors, such as an array of sensors. For example, the transport mechanism can include a load present sensor, a grip range sensor, a station sensor, a station load sensor, a rail sensor, an actuator feedback sensor, a combination thereof, or the like. The one or more sensors can communicate with an onboard processor of the transport mechanism and/or can communicate with the with the processor of the autonomous mobile robot and/or tugger cart system of the tugged cart. When connected to the processor of the autonomous mobile robot and/or tugger cart system, the processor of these systems can be programed to communicate and send commands to the transport mechanism, thereby directing the components of the transport mechanism to take action based on the sensed data. Additionally, the sensors of the transport mechanism send data to the processor of the autonomous mobile robot and/or tugger cart system such that the autonomous mobile robot and/or tugger cart system can take actions based on the data.

The load present sensor can sense whether a load carrier is on the conveyor bed. The load present sensor can be a weight sensor, an optical sensor, a radar sensor, an ultrasonic sensor, a combination thereof, or the like. When the load present sensor senses a load on the conveyor bed, the autonomous mobile robot and/or the tugged cart can autonomously move from the stationary area to a pre-programmed destination within the industrial setting.

The station sensor can sense a stationary area is present in front of the transport mechanism. The station sensor can be an optical sensor, a radar sensor, an ultrasonic sensor, a combination thereof, or the like. When the transport mechanism determines that the transport mechanism is in a proper position in front of the stationary area via the station sensor, the transport mechanism can determine whether there is a load carrier present on the stationary area.

The station load sensor can sense whether a load carrier is present on the stationary area. The station load sensor can be an optical sensor, a radar sensor, an ultrasonic sensor, a combination thereof, or the like. When the transport mechanism determines a load carrier is present on the stationary area, the processor of the transport mechanism, the autonomous mobile robot, or the tugger cart system can initiate the first activation such that the motor drives the traversing unit towards the front end of the transport mechanism.

The grip range sensor can sense a distance range of the load carrier to the gripping mechanism when the gripping mechanism is extending to grasp the load carrier. The grip range sensor can be an optical sensor, a radar sensor, an ultrasonic sensor, a motion sensor, a positional sensor, a combination thereof, or the like. When the transport mechanism determines a distance of the load carrier to the gripping mechanism, adjustments can be made such that the gripping mechanism is able to grasp the load carrier.

The rail sensor can sense the location of the carriage on the track. The rail sensor can be an optical sensor, a radar sensor, an ultrasonic sensor, a motion sensor, a positional sensor, a combination thereof, or the like. By determining the location of the carriage on the track, the transport mechanism can make the adjustments such that the gripping mechanism is able to grasp the load carrier, and the transport mechanism can determine whether the load carrier is fully loaded on the conveyor bed.

The actuator feedback sensor can sense the state of the actuator of the gripping mechanism, i.e., whether the actuator is extended or retracted. The actuator feedback sensor can be an optical sensor, a radar sensor, an ultrasonic sensor, a motion sensor, a positional sensor, a combination thereof, or the like. By determining the state of the actuator of the gripping mechanism, the transport mechanism can determine whether the gripping mechanism is opened to grip the load carrier, whether the gripping mechanism is properly gripping a load carrier, and the overall state of the gripping mechanism. When the actuator feedback sensor determines that the gripping mechanism is properly gripping the load carrier, the second activation can be initiated such that the motor retracts the traversing unit towards the rear end of the frame, loading the load carrier on the conveyor bed.

The present invention further includes a method of transporting a load carrier from a stationary area in a warehouse. The method includes mounting the transport mechanism to an autonomous mobile robot. The method further includes programing the autonomous mobile robot to autonomously traverse the warehouse including at least traversing to the stationary area and from the stationary area to an endpoint. The autonomous mobile robot traverses the warehouse to the stationary area, the motor of the transport mechanism drives the traversing unit to the loading end of the conveyor bed, the gripping mechanism of the transport mechanism grips the load carrier disposed on the stationary area, the motor retracts the traversing unit towards the rear end of the frame of the transport mechanism, thereby loading the load carrier onto the conveyor bed, and the autonomous mobile robot traverses the warehouse to the endpoint.

At the endpoint, the motor of the transport mechanism drives the traversing unit to the loading end of the conveyor bed, thereby unloading the load carrier from the conveyed bed, the gripping mechanism of the transport mechanism releases the grip of the load carrier, and the motor retracts the traversing unit towards the rear end of the frame.

As used herein, the term “programming” is defined as using the software pre-loaded on a memory of the autonomous mobile robot or loading software on to the memory of the autonomous mobile robot, where the loaded software in combination with a processor is used to determine routes within the industrial setting, such as a warehouse, such that the autonomous mobile robot uses onboard processor(s), sensors, and similar technologies to autonomously navigate within the industrial setting.

The present invention further includes a method of transporting a load carrier from a stationary area in a warehouse using the transport mechanism of the present invention mounted to a tugged cart. The method includes driving the tugged cart to a stationary area. The motor of the transport mechanism drives the traversing unit to the loading end of the conveyor bed, the gripping mechanism of the transport mechanism grips the load carrier disposed on the stationary area, the motor retracts the traversing unit towards the rear end of the frame of the transport mechanism, thereby loading the load carrier onto the conveyor bed. The method further includes driving the tugged cart to an endpoint of the warehouse. At the endpoint, the motor of the transport mechanism drives the traversing unit to the loading end of the conveyor, thereby unloading the load carrier from the conveyer bed, the gripping mechanism of the transport mechanism releases the grip of the load carrier, and the motor retracts the traversing unit towards the rear end of the frame.

The transport mechanism can utilize any of the sensors described herein to carry out any of the processes described herein.

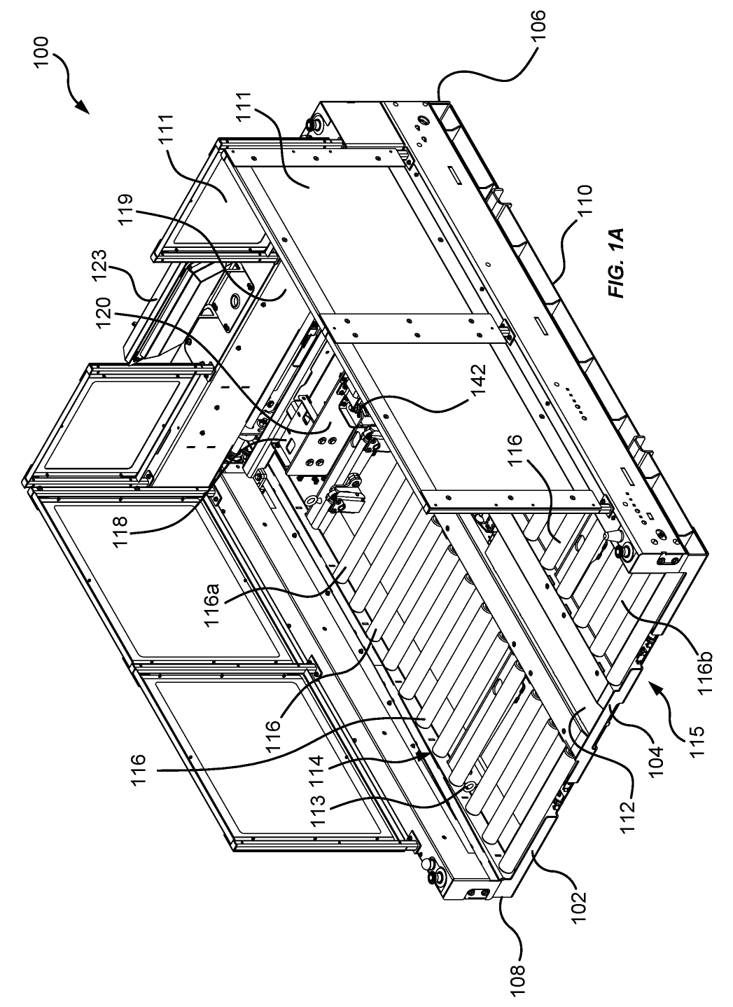

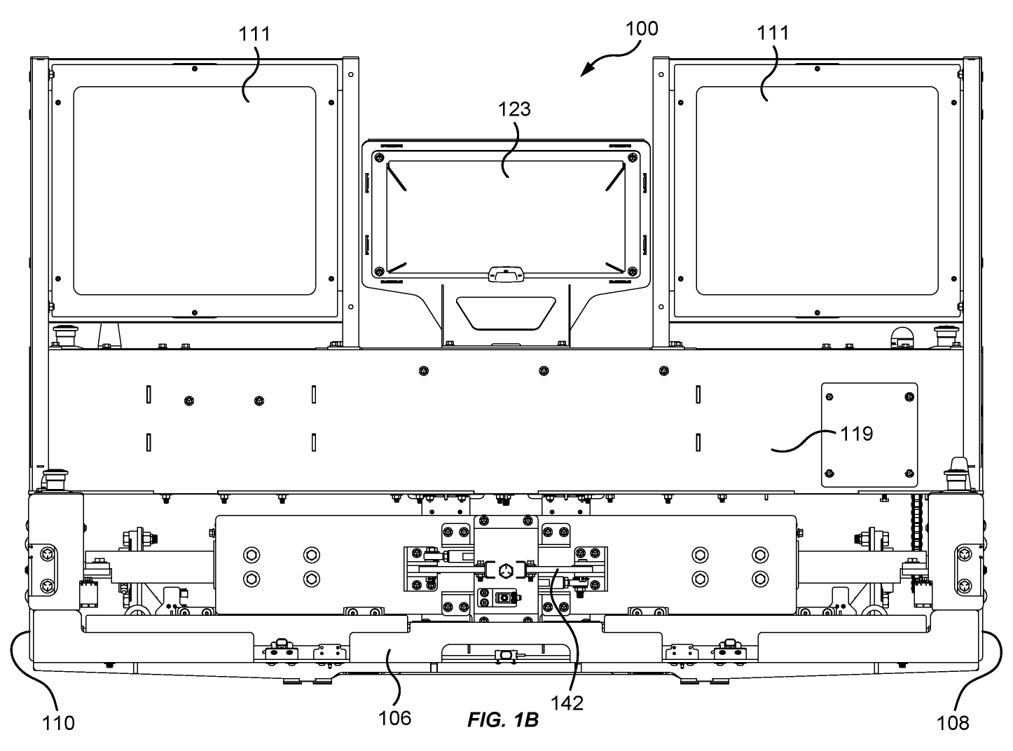

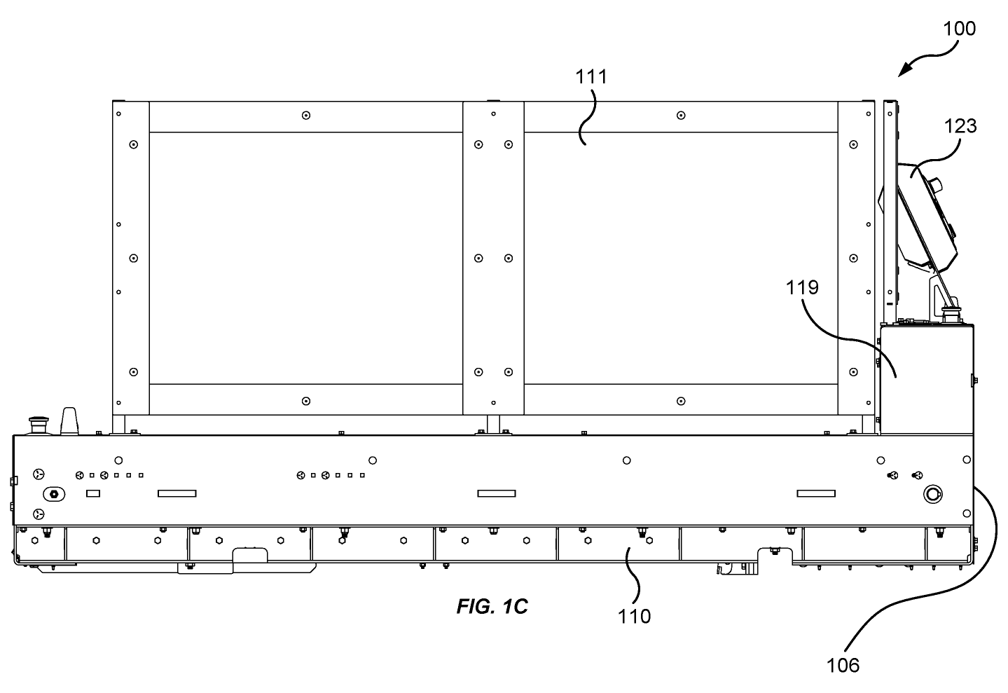

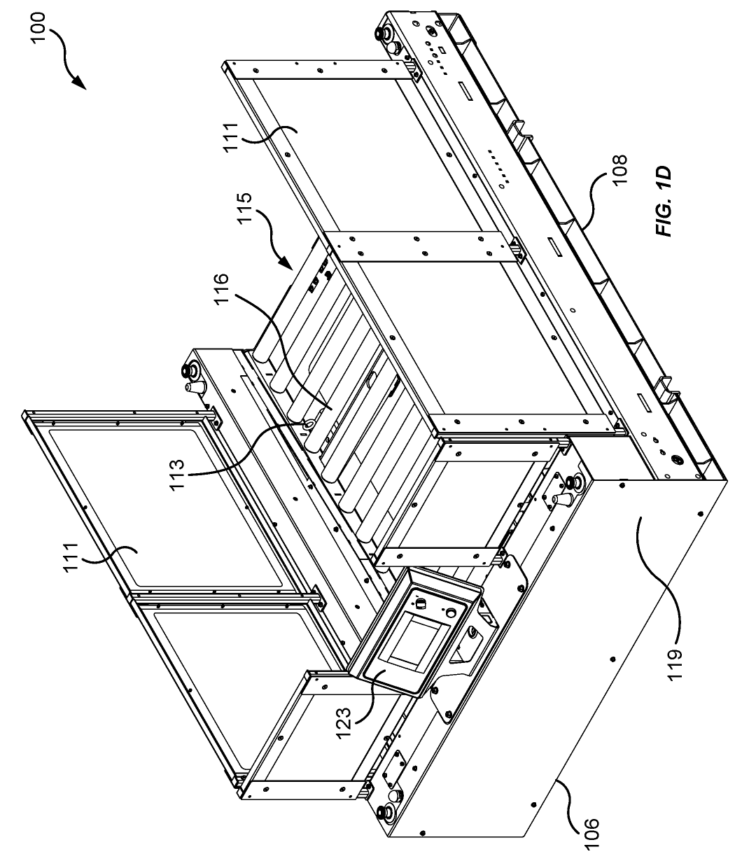

With reference now to the drawings, FIG. 1A is a front perspective view of a transport mechanism 100 of an embodiment of the present invention. FIG. 1B is a rear view of the transport mechanism 100 of FIG. 1A. FIG. 1C is a side view of the transport mechanism 100 of FIG. 1A. FIG. 1D is a rear perspective view of the transport mechanism 100 of FIG. 1A.

The transport mechanism 100 includes a frame 102 having a front end 104, a rear end 106, a first side 108, and a second side 110. The frame 102 can further include a central partition 112. A conveyor bed 114 is coupled to the frame 102. The conveyor bed 114 defines a loading surface. The conveyor bed 114 includes a loading end 115 at the front end 104 of the frame 102.

The conveyor bed 114 includes a plurality of rollers 116, including a first set of rollers 116a and a second set of rollers 116b. The first set of rollers 116a are rotatably coupled to the first side 108 and the central partition 112 and a second set of rollers 116b are rotatably coupled to the second side 110 and the central partition 112. The plurality of rollers 116 are substantially parallel to one another and extend in a direction from the first side 108 to the second side 110. The first set of rollers 116a, the second set of rollers 116b, and the central partition 112 define the loading surface. The plurality of rollers 116 are non-powered rollers.

The transport mechanism 100 further includes a traversing unit 118. The traversing unit 118 is a carriage 120. The traversing unit 118 is unit movably coupled to the frame 102 and is configured to traverse along the loading surface in a direction from the rear end 106 to the front end 104 of the frame 102. A gripping mechanism 142 is coupled to the traversing unit 118 and is configured to grip a load carrier (not shown).

The transport mechanism 100 further includes an interface 123. The interface 123 can include a plurality of buttons, a touchscreen, a voice activator, and the like. The interface 123 allows a user to control and/or program the mechanisms of the transport mechanism 100 and communicate with an autonomous mobile robot.

The transport mechanism 100 can further include frame walls 111. The frame walls 111 are secured to the first side 108, the second side 110, and the rear end 106 of the frame. The frame walls 111 can further secure the load carrier on the conveyor bed 114, preventing the load carrier from falling off the transport mechanism 100 when traversing around an industrial setting.

A plurality of eyelets 113 can be secured to the frame 102 of the transport mechanism 100. The plurality of eyelets 113 can connect with hooks and straps, such that the transport mechanism 100 can be lifted up and mounted to an autonomous mobile robot and/or the tugged cart.

The transport mechanism 100 can further include a frame housing 119 coupled to the frame 102. The frame housing 119 can house electrical components, such as printed circuit boards, a processor and memory, electrical wiring, a motor, and the like.

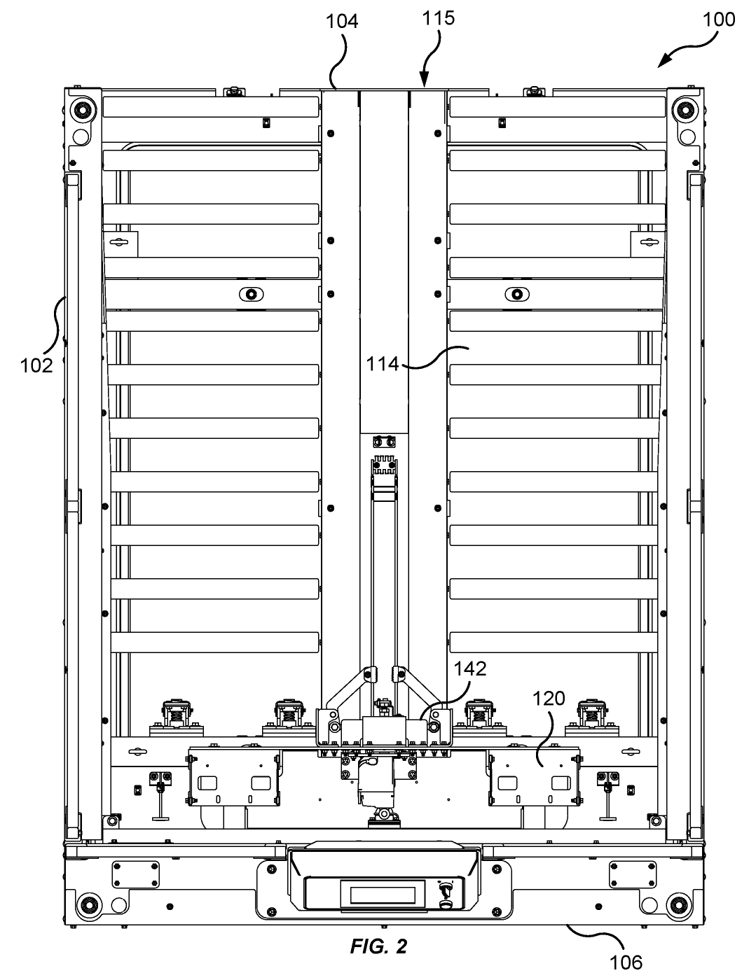

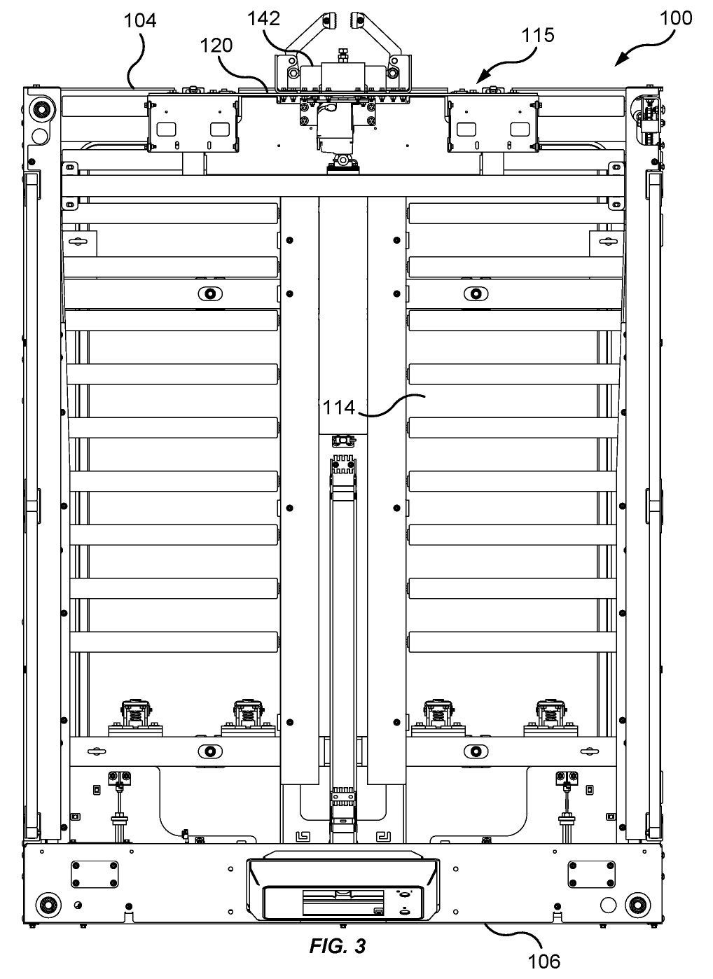

FIG. 2 is a top view of the transport mechanism 100, illustrating the carriage 120 in a retracted state. FIG. 3 is a top view of the transport mechanism 100, illustrating the carriage 120 in an extended state. In the retracted state, the carriage 120 is disposed towards the rear end 106 of the frame 102. The carriage 120 is movably coupled to the frame 102 and is configured to traverse along the loading surface in a direction from the rear end 106 to the front end 104 of the frame 102. FIG. 3 illustrates the carriage 120 after the carriage 120 has traversed to the front end 104. The gripping mechanism 142 is disposed at the loading end 115 of the conveyor bed 114, such that the gripping mechanism 142 can grip a load carrier. Once the load carrier is gripped, the carriage 120 traverses back towards the rear end 106 so that the load carrier is loaded onto the conveyor bed 114.

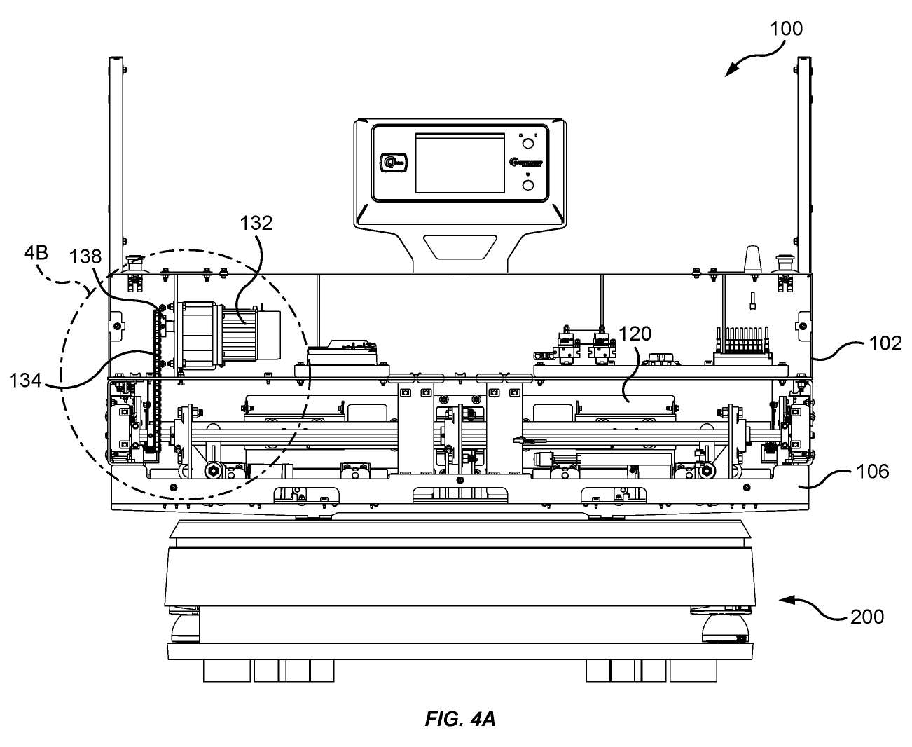

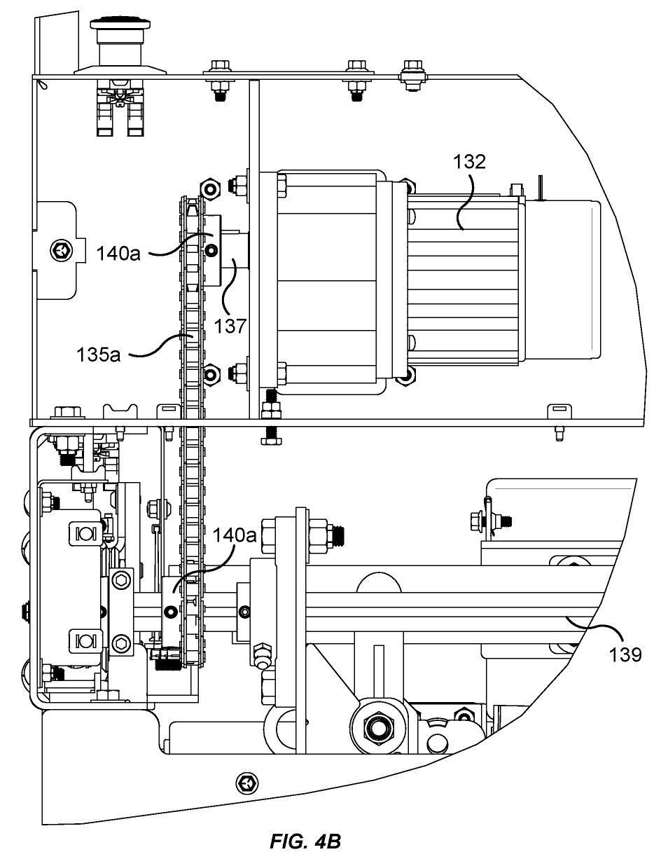

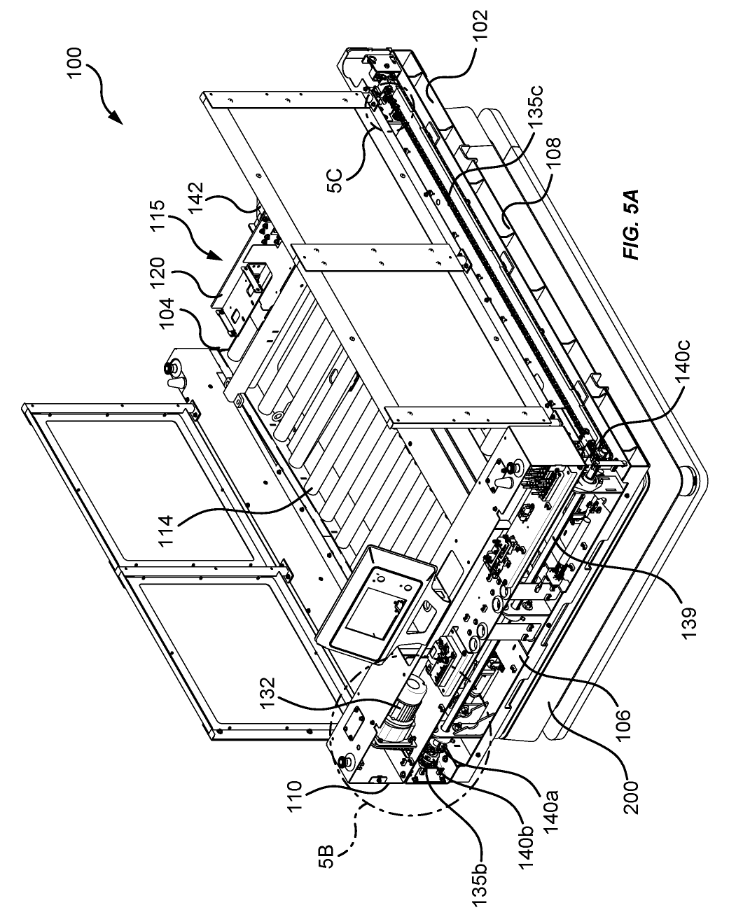

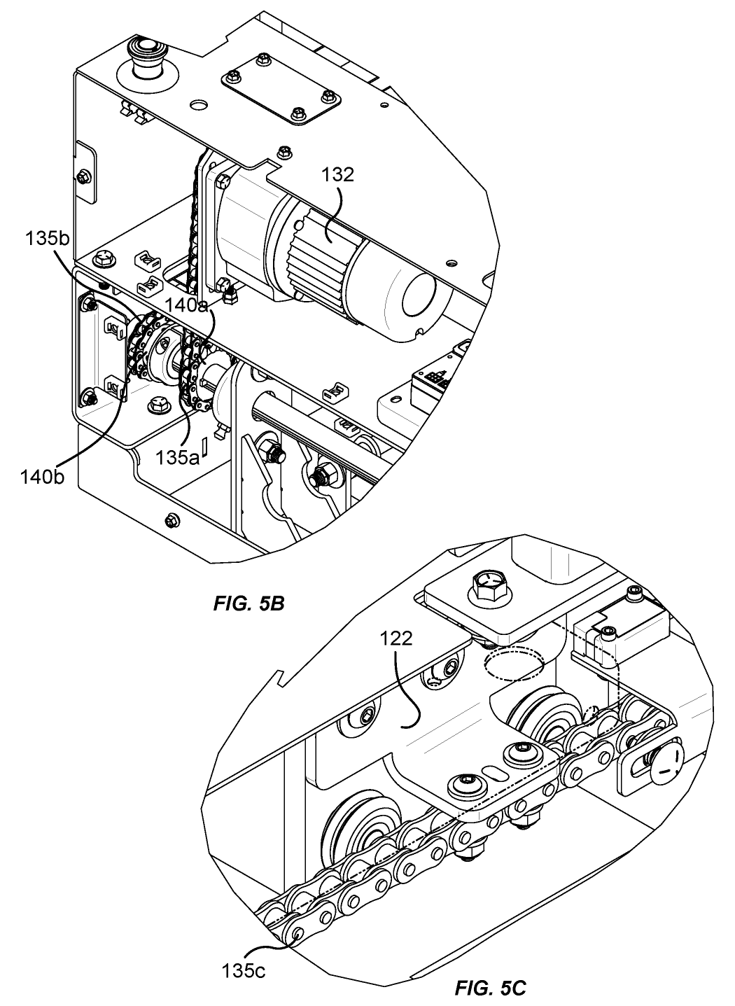

FIG. 4A is a rear view of the transport mechanism 100, illustrating the transport mechanism 100 mounted to an autonomous mobile robot 200 and further illustrating internal components of the transport mechanism 100. FIG. 4B is a detail view of the transport mechanism 100 shown in FIG. 4A. FIG. 5A is a rear perspective view of the transport mechanism 100, illustrating the transport mechanism 100 mounted to an autonomous mobile robot 200 and further illustrating internal components of the transport mechanism 100. FIG. 5B is a detail view of the transport mechanism 100 shown in FIG. 5A. FIG. 5C is a detail view of the transport mechanism 100 shown in FIG. 5A.

As illustrated in FIGS. 4A and 5A, the transport mechanism 100 is secured to an autonomous mobile robot 200. A bottom of the frame 102 can be bolted to a top surface of the autonomous mobile robot 200. As an option, the frame 102 can be welded to the autonomous mobile robot 200. When the transport mechanism 100 is secured to the autonomous mobile robot 200, electrical connections can be made between the autonomous mobile robot 200 such that the power source of the autonomous mobile robot 200 can provide power to the transport mechanism 100, and data, such as commands and sensor data, can be communicated between the autonomous mobile robot 200 and the transport mechanism 100.

As illustrated in FIGS. 4A-5C, the transport mechanism 100 further includes a motor 132 mounted to the frame 102. The motor 132 is configured to drive the carriage 120. Upon a first activation, the motor 132 drives the carriage 120 towards the front end 104 such that the gripping mechanism 142 is disposed at the loading end 115 of the conveyor bed 114 and upon a second activation, the motor 132 retracts the carriage 120 towards the rear end 106 of the frame 102.

The motor 132 can drive the carriage 120 using a series of drive loops 134 and rotaries 138. As illustrated, the transport mechanism 100 can include a first pair of gears 140a and a first chain 135a wrapped around the first pair of gears 140a. The transport mechanism 100 can further include a second pair of gears 140b and a second chain 135b wrapped around the second pair of gears 140b. The transport mechanism 100 can further include a third pair of gears 140c and a third chain 135c wrapped around the third pair of gears 140c. The second chain 135b can be secured to the frame 102 by the second pair of gears 140b along the length of the second side 110 of the frame 102 and the third chain 135c can be secured to the frame 102 by the third pair of gears 140c along the length of first side 108 of the frame 102. The motor 132 can be secured to one of the first pair of gears 140a by a drive rod 137. The other of the first pair of gears 140a is connected to a gear connector rod 139. The gear connector rod 139 is connected to one of the second pair of gears 140b and one of the third pair of gears 140c.

The carriage 120 can be mounted to the second chain 135b and the third chain 135c by a mounting bracket 122. When powered, the motor 132 rotates the drive rod 137, which in turn rotates the first pair of gears 140a and the first chain 135a, the gear connector rod 139, the second pair of gears 140b, the second chain 135b, the third pair of gears 140c, and the third chain 135c. The motor 132 can rotate the drive rod 137 in a clockwise direction and a counterclockwise direction to move the carriage 120 towards the loading end 115 and back towards the rear end 106.

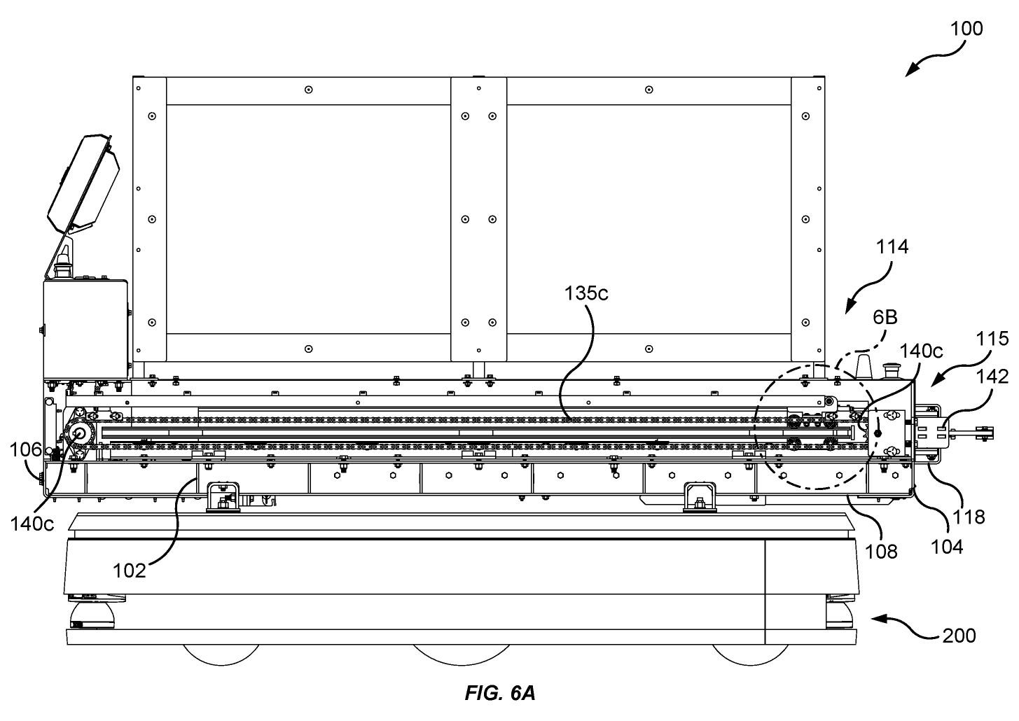

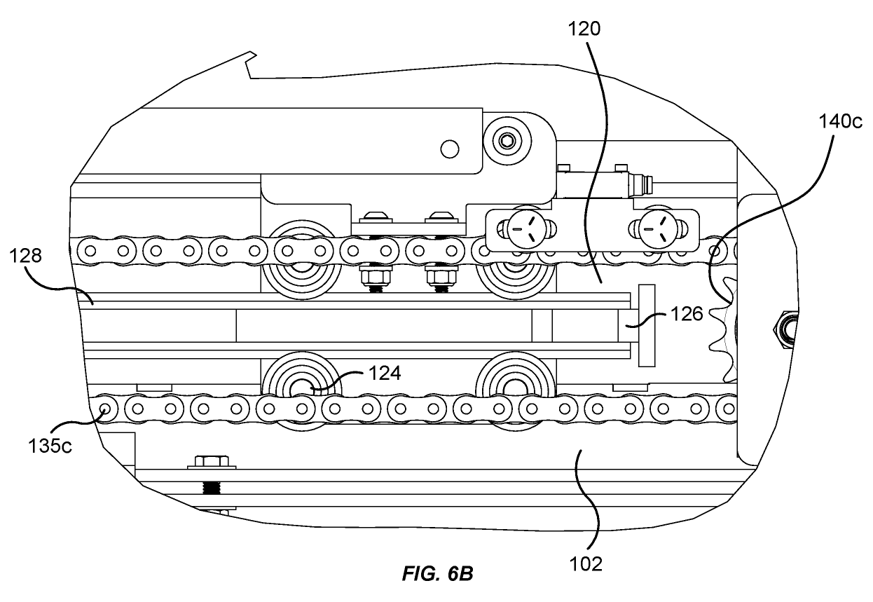

FIG. 6A is a side view of the transport mechanism 100, illustrating the transport mechanism 100 mounted to the autonomous mobile robot 200 and further illustrating internal components of the transport mechanism 100. Specifically, FIG. 6A illustrates the first side 108 of the transport mechanism 100 with a panel removed from the frame 102. FIG. 6A illustrates the third pair of gears 140c and the third chain 135c wrapped around the third pair of gears 140c. The traversing unit 118 is disposed at the loading end 115 of the conveyor bed 114, such that the gripping mechanism 142 is extending beyond the loading end 115 to grip a load carrier. FIG. 6B is a detail view of the transport mechanism 100 shown in FIG. 6A.

The transport mechanism 100 further includes a track 126 secured to the frame 102. The carriage 120 traverses along the track 126. The track 126 extends along the frame 102 in a direction from the front end 104 to the rear end 106 and the carriage 120 is moveable along the track 126. The track 126 can include a rail 128 extending along the frame 102 at the first side 108 and a rail 128 extending along the frame 120 at the second side 110. The carriage 120 can further include wheels 124 that roll along the track 126. The track 126 elevates the carriage 120 above the loading surface.

As illustrated in FIGS. 6A and 6B, the carriage 120 includes a first set of wheels 124 secured to a rail 128 at the first side and a second set of wheels 124 secured to another rail 128 at the second side 110. Each set of wheels 124 includes a top pair of wheels 124 and a bottom pair of wheels 124. The respective rails 128 fit in between the top and bottom pair of wheels 128. Each of the wheels 124 include a circumferential V-groove. The circumferential V-groove guides the wheels 124 along the rails 128.

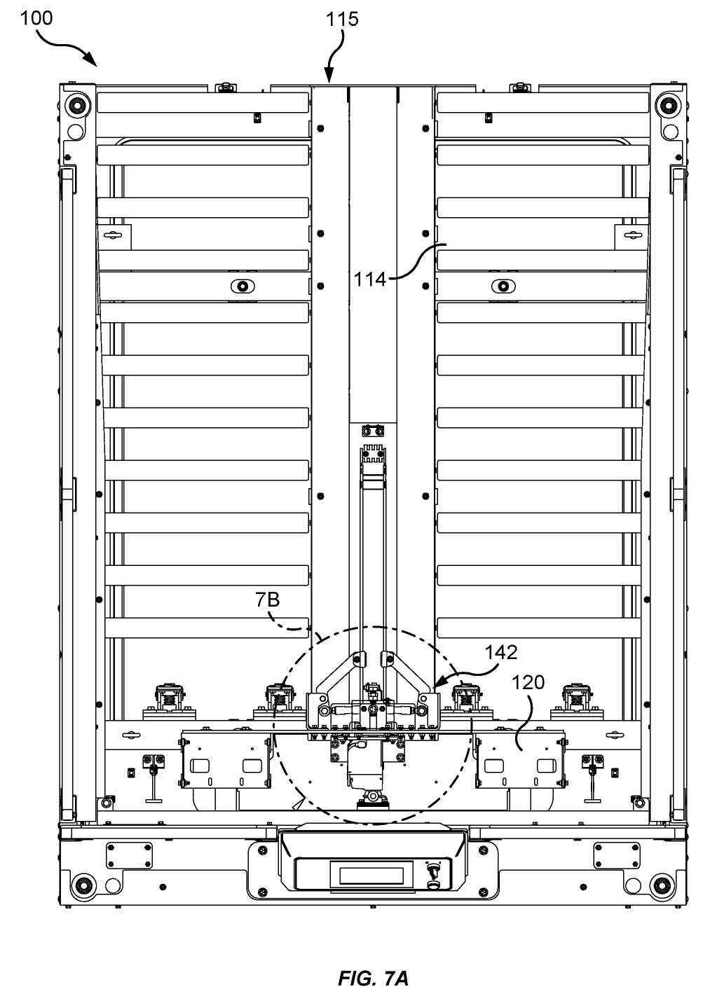

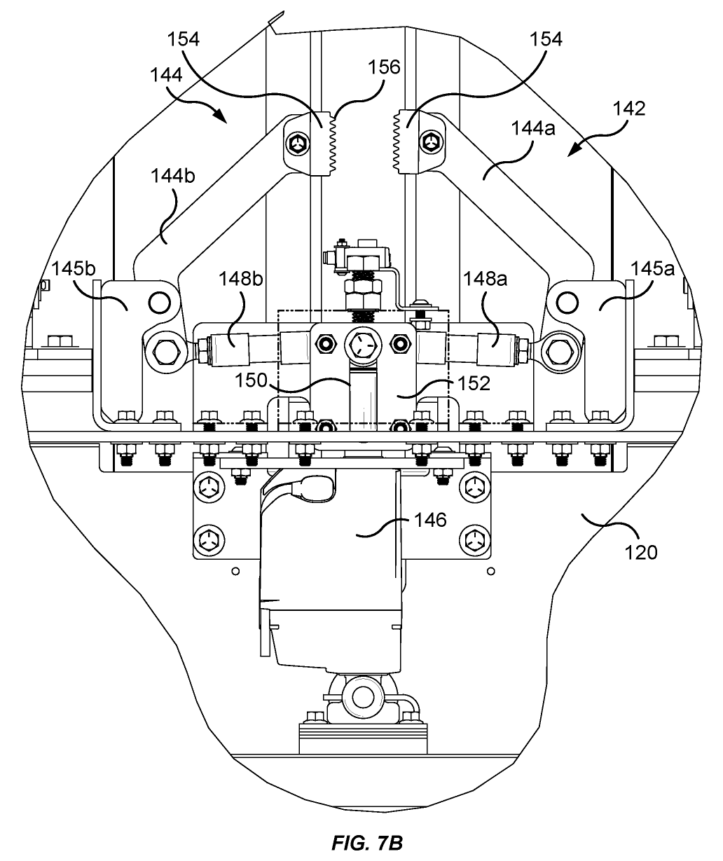

FIG. 7A is a top view of the transport mechanism 100, illustrating a carriage 120 in a retracted state of the conveyor bed 114. FIG. 7B is a detail view of the transport mechanism 100 shown in FIG. 7A, showing details of the gripping mechanism 142.

The gripping mechanism 142 includes a jaw 144 configured to open and close. The jaw 144 is located at a front side of the carriage 120, which is facing towards the loading end 115. The gripping mechanism 142 can further include a linear actuator 146 that opens the jaw 144 upon a first activation and closes the jaw 144 upon a second activation.

The jaw 144 of the gripping mechanism 142 can include a first jaw member 144a and a second jaw member 144b. The first jaw member 144a can be pivotably coupled to a first bracket 145a mounted to the carriage 120. A first link 148a is pivotably coupled to the first jaw member 144a at a first end and pivotably coupled to a connector rod 150 at a second end. The second jaw member 144b is pivotably coupled to a second bracket 145b mounted to the carriage 120. A second link 148b can be pivotably coupled to the second jaw member 144b at a first end and pivotably coupled to the connector rod 150 at a second end. The connector rod 150 is disposed within a guide 152, allowing the connector rod 150 to move towards the jaw 144 and away from the jaw 144. The connector rod 150 is coupled to a linear actuator 146 that moves the connector rod 150 within the guide 152. Upon the first activation, the linear actuator 146 pulls the connector rod 150 back within the guide 152, which in turn opens the jaw 144. Upon the second activation, the linear actuator 146 pushes the connector rod 150 forward within the guide 152, which in turn closes the jaw 144 and locks the jaw 144 in place.

The jaw 144 includes gripping portions 154 at an end of the first jaw member 144a and the second jaw member 144b. The gripping portions 154 include a plurality of spikes 156 extending from the surfaces of the gripping portions 154. The plurality of spikes 156 of the first jaw member 144a face the plurality of spikes 156 of the second jaw member 144b. The gripping portion 154 allows the jaw 144 to firmly grasp the load carrier. The gripping portions 154 can be pivotably connected to the jaw members 144a, 144b to firmly grip the load carrier.

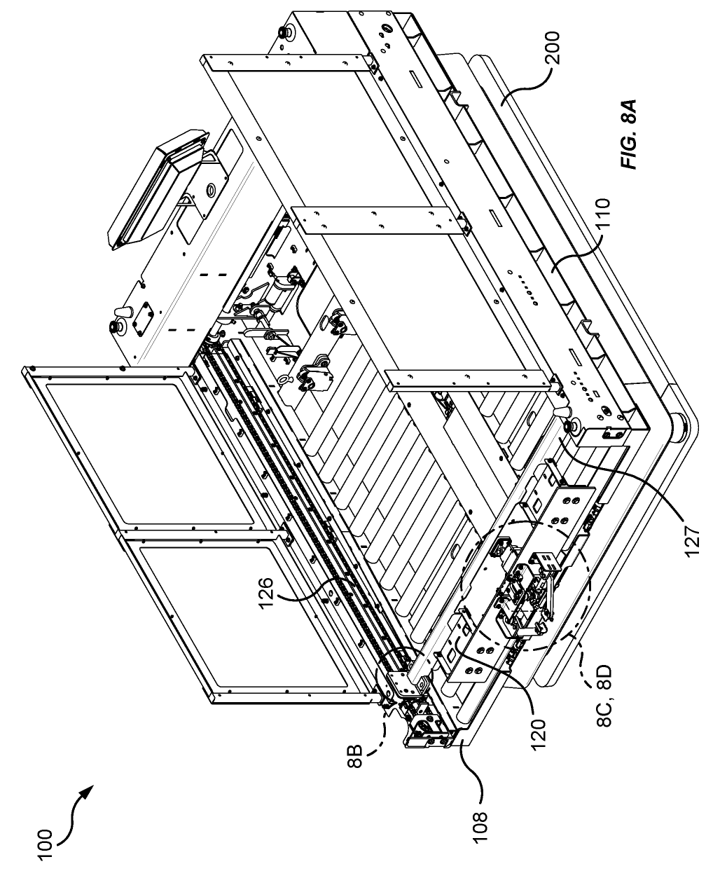

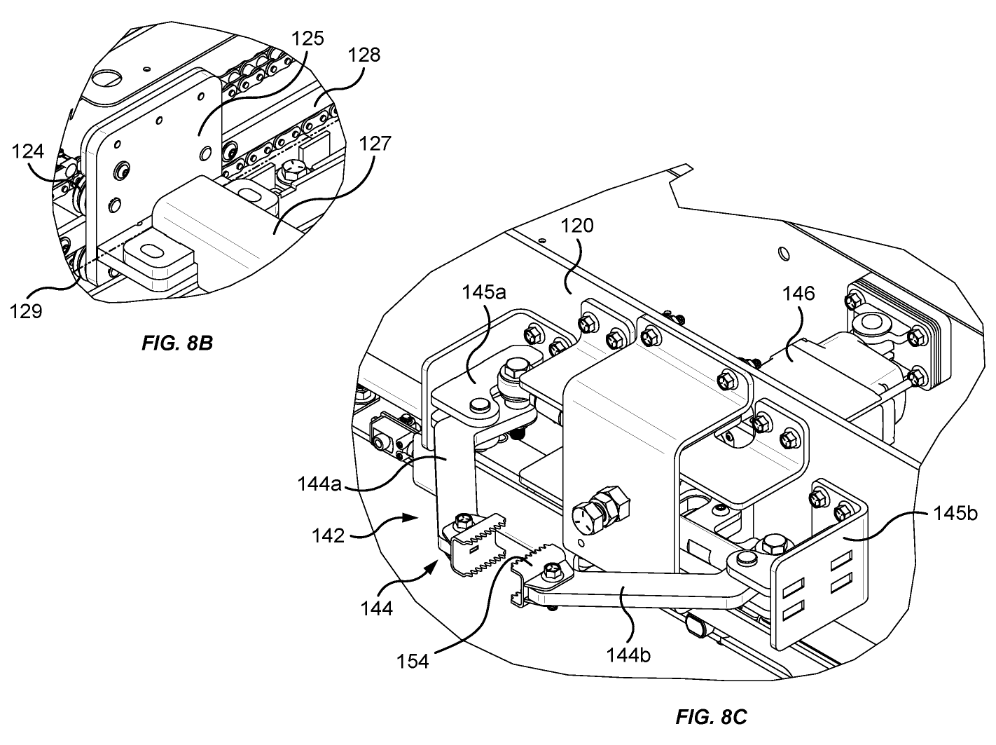

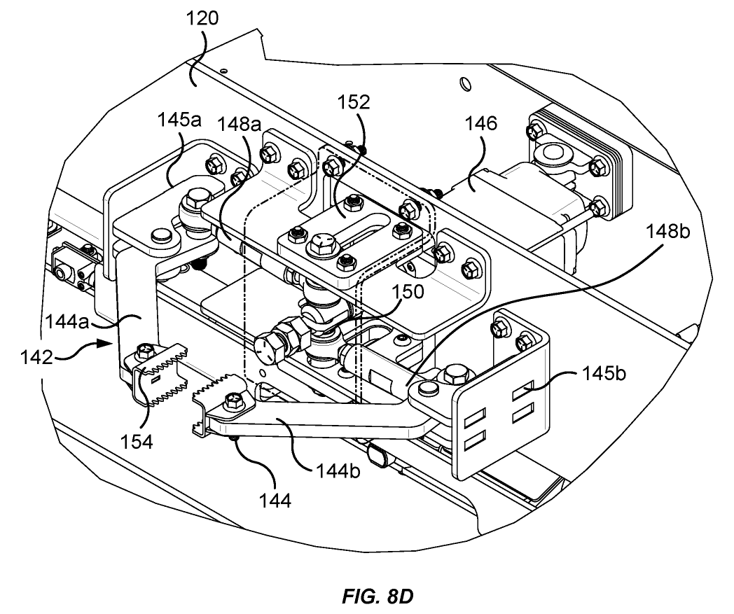

FIG. 8A is a front perspective view of the transport mechanism 100, illustrating the transport mechanism 100 mounted to an autonomous mobile robot 200 and further illustrating the carriage 120 in an extended position. FIG. 8B is a detail view of the transport mechanism 100 shown in FIG. 8A. FIG. 8C is a detail view of the transport mechanism 100 shown in FIG. 8A. FIG. 8D is a detail view of the transport mechanism 100 shown in FIG. 8A, illustrating internal components of a gripping mechanism 142.

FIGS. 8A and 8B further illustrate the connection between the carriage 120 and the track 126. A carriage rod 127 can be secured to the carriage 120 and can extend from the first side 108 to the second side 110. Wheel plates 125 are mounted at each end of the carriage rod 127. The first set of wheels 124 are rotatably secured to a first wheel plate 125 and the second set of wheels 124 are rotatably secured to a second wheel plate 125. The respective first and second rails 128 fit in between the top pair and the bottom pair of the first and second sets of wheels 124. FIG. 8B illustrates the circumferential V-groove 129 of the wheels 124.

FIGS. 8C and 8D further illustrate the gripping mechanism 142. As previously described, the gripping mechanism 142 includes the first jaw member 144a and the second jaw member 144b. The first jaw member 144a is pivotably coupled to the first bracket 145a mounted to the carriage 120. The first link 148a is pivotably coupled to the first jaw member 144a at the first end and pivotably coupled to the connector rod 150 at the second end. The second jaw member 144b is pivotably coupled to the second bracket 145b mounted to the carriage 120. A second link 148b is pivotably coupled to the second jaw member 144b at a first end and pivotably coupled to the connector rod 150 at a second end. The connector rod 150 is disposed within a guide 152, allowing the connector rod 150 to move towards the jaw 144 and away from the jaw 144. The connector rod 150 is coupled to a linear actuator 146 that moves the connector rod 150 within the guide 152. Upon the first activation, the linear actuator 146 pulls the connector rod 150 back within the guide 152, which in turn opens the jaw 144. Upon the second activation, the linear actuator 146 pushes the connector rod 150 forward within the guide 152, which in turn closes the jaw 144 and locks the jaw 144 in place. The jaw 144 further includes gripping portions 154, as described herein.

The present invention includes the following aspects/embodiments/features in any order and/or in any combination:

1. A transport mechanism for a load carrier, the transport mechanism comprising:

a frame comprising a front end, a rear end, a first side, and a second side;

a conveyor bed coupled to the frame and forming a loading surface, the conveyor bed comprising a loading end at the front end of the frame;

a traversing unit movably coupled to the frame and configured to traverse along the loading surface in a direction of the rear end to the front end of the frame;

a gripping mechanism coupled to the traversing unit and configured to grip a load carrier; and

a motor configured to drive the traversing unit towards the front end such that the gripping mechanism is disposed at the loading end of the conveyor bed and retract the traversing unit towards the rear end of the frame.

2. The transport mechanism of any preceding or following embodiment/feature/aspect, wherein the conveyor bed comprises a plurality of rollers substantially parallel to one another and extending in a direction from the first side to the second side, the plurality of rollers at least partially defining the loading surface.

3. The transport mechanism of any preceding or following embodiment/feature/aspect, wherein the frame further comprises a central partition running from the front end to the rear end along the conveyor bed, the central partition partially defining the loading surface.

4. The transport mechanism of any preceding or following embodiment/feature/aspect, wherein the plurality of rollers comprises a first set of rollers rotatably coupled to the first side and the central partition and a second set of rollers rotatably coupled to the second side and the central partition.

5. The transport mechanism of any preceding or following embodiment/feature/aspect, wherein the plurality of rollers are non-powered rollers.

6. The transport mechanism of any preceding or following embodiment/feature/aspect, further comprising a track extending along the frame in a direction from the front end to the rear end, and the traversing unit is a carriage that is moveable along the track.

7. The transport mechanism of any preceding or following embodiment/feature/aspect, wherein the track comprises a first rail extending along the frame at the first side and a second rail extending along the frame at the second side.

8. The transport mechanism of any preceding or following embodiment/feature/aspect, wherein the carriage further comprises wheels that roll along the track, wherein the track elevates the carriage above the loading surface.

9. The transport mechanism of any preceding or following embodiment/feature/aspect, further comprising a drive loop secured to the frame by rotaries, wherein the carriage is coupled to the drive loop and the motor drives the drive loop.

10. The transport mechanism of any preceding or following embodiment/feature/aspect, wherein the wheels each comprise a circumferential V-groove, wherein the circumferential V-groove guides the wheels along the first rail and the second rail.

11. The transport mechanism of any preceding or following embodiment/feature/aspect, wherein the gripping mechanism comprises a jaw configured to open and close.

12. The transport mechanism of any preceding or following embodiment/feature/aspect, further comprising an actuator that opens the jaw upon a first activation and closes the jaw upon a second activation.

13. The transport mechanism of any preceding or following embodiment/feature/aspect, wherein the jaw is sized to grasp a center stringer of a pallet.

14. The transport mechanism of any preceding or following embodiment/feature/aspect, further comprising an interface configured to control the motor and the gripping mechanism.

15. The transport mechanism of any preceding or following embodiment/feature/aspect, wherein the frame is coupled to an autonomous mobile robot and/or a tugged cart.

16. The transport mechanism of any preceding or following embodiment/feature/aspect, wherein the frame is releasably attached to the autonomous mobile robot and/or the tugged cart.

17. The transport mechanism of any preceding or following embodiment/feature/aspect, further comprising a frame housing that houses electrical wiring of the transport mechanism, the electrical wiring comprising at least one power connector configured to connect to a power source of the autonomous mobile robot and/or the tugged cart.

18. The transport mechanism of any preceding or following embodiment/feature/aspect, further comprising frame walls extending vertically at the first side, the second side, and the rear side, wherein a clearance is provided at the loading end.

19. A method of transporting a load carrier from a stationary area in a warehouse comprising:

mounting the transport mechanism of any preceding or following embodiment/feature/aspect to an autonomous mobile robot; and

programing the autonomous mobile robot to autonomously traverse the warehouse comprising at least traversing to the stationary area and from the stationary area to an endpoint, wherein

the autonomous mobile robot traverses the warehouse to the stationary area,

the motor of the transport mechanism drives the traversing unit to the loading end of the conveyor bed,

the gripping mechanism of the transport mechanism grips the load carrier disposed on the stationary area,

the motor retracts the traversing unit towards the rear end of the frame of the transport mechanism, thereby loading the load carrier onto the conveyor bed, and

the autonomous mobile robot traverses the warehouse to the endpoint.

The method of any preceding or following embodiment/feature/aspect, wherein, at the endpoint, the motor of the transport mechanism drives the traversing unit to the loading end of the conveyor, thereby unloading the load carrier from the conveyed bed, the gripping mechanism of the transport mechanism releases the grip of the load carrier, and the motor retracts the traversing unit towards the rear end of the frame.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such a range is separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A transport mechanism for a load carrier, the transport mechanism comprising:
a frame comprising a front end, a rear end, a first side, and a second side;
a conveyor bed coupled to the frame and forming a loading surface, the conveyor bed comprising a loading end at the front end of the frame;
a traversing unit movably coupled to the frame and configured to traverse along the loading surface in a direction of the rear end to the front end of the frame;
a gripping mechanism coupled to the traversing unit and configured to grip a load carrier; and
a motor configured to drive the traversing unit towards the front end such that the gripping mechanism is disposed at the loading end of the conveyor bed and retract the traversing unit towards the rear end of the frame.

2. The transport mechanism of claim 1, wherein the conveyor bed comprises a plurality of rollers substantially parallel to one another and extending in a direction from the first side to the second side, the plurality of rollers at least partially defining the loading surface.

3. The transport mechanism of claim 2, wherein the frame further comprises a central partition running from the front end to the rear end along the conveyor bed, the central partition partially defining the loading surface.

4. The transport mechanism of claim 3, wherein the plurality of rollers comprises a first set of rollers rotatably coupled to the first side and the central partition and a second set of rollers rotatably coupled to the second side and the central partition.

5. The transport mechanism of claim 2, wherein the plurality of rollers are non-powered rollers.

6. The transport mechanism of claim 1, further comprising a track extending along the frame in a direction from the front end to the rear end, and the traversing unit is a carriage that is moveable along the track.

7. The transport mechanism of claim 6, wherein the track comprises a first rail extending along the frame at the first side and a second rail extending along the frame at the second side.

8. The transport mechanism of claim 7, wherein the carriage further comprises wheels that roll along the track, wherein the track elevates the carriage above the loading surface.

9. The transport mechanism of claim 8, further comprising a drive loop secured to the frame by rotaries, wherein the carriage is coupled to the drive loop and the motor drives the drive loop.

10. The transport mechanism of claim 8, wherein the wheels each comprise a circumferential V-groove, wherein the circumferential V-groove guides the wheels along the first rail and the second rail.

11. The transport mechanism of claim 1, wherein the gripping mechanism comprises a jaw configured to open and close.

12. The transport mechanism of claim 11, further comprising an actuator that opens the jaw upon a first activation and closes the jaw upon a second activation.

13. The transport mechanism of claim 11, wherein the jaw is sized to grasp a center stringer of a pallet.

14. The transport mechanism of claim 1, further comprising an interface configured to control the motor and the gripping mechanism.

15. The transport mechanism of claim 1, wherein the frame is coupled to an autonomous mobile robot and/or a tugged cart.

16. The transport mechanism of claim 15, wherein the frame is releasably attached to the autonomous mobile robot and/or the tugged cart.

17. The transport mechanism of claim 15, further comprising a frame housing that houses electrical components of the transport mechanism, the electrical components comprising at least one power connector configured to connect to a power source of the autonomous mobile robot and/or the tugged cart.

18. The transport mechanism of claim 1, further comprising frame walls extending vertically at the first side, the second side, and the rear side, wherein a clearance is provided at the loading end.

19. A method of transporting a load carrier from a stationary area in a warehouse comprising:
mounting the transport mechanism of claim 1 to an autonomous mobile robot; and
programing the autonomous mobile robot to autonomously traverse the warehouse comprising at least traversing to the stationary area and from the stationary area to an endpoint, wherein
the autonomous mobile robot traverses the warehouse to the stationary area,
the motor of the transport mechanism drives the traversing unit to the loading end of the conveyor bed,
the gripping mechanism of the transport mechanism grips the load carrier disposed on the stationary area,
the motor retracts the traversing unit towards the rear end of the frame of the transport mechanism, thereby loading the load carrier onto the conveyor bed, and
the autonomous mobile robot traverses the warehouse to the endpoint.

20. The method of claim 19, wherein, at the endpoint, the motor of the transport mechanism drives the traversing unit to the loading end of the conveyor, thereby unloading the load carrier from the conveyed bed, the gripping mechanism of the transport mechanism releases the grip of the load carrier, and the motor retracts the traversing unit towards the rear end of the frame.
